(19) United States
(12) Patent Application Publication
(10) Pub. No.: US 2007/0235559 A1
(43) Pub. Date: Oct. 11, 2007

(54) Flow control valve

(75) Inventor: Yoshiaki Miyake, Kanagawa (JP)

Correspondence Address: NIXON PEABODY, LLP, 401 9TH STREET, NW, SUITE 900, WASHINGTON, DC, 20004-2128, US

(73) Assignee: NANKAI CO., LTD, Minamiashigara-shi (JP)

(21) Appl. No.: 11/384,423

(22) Filed: Mar. 21, 2006

(51) Int. Cl. B05B 15/10

(52) U.S. Cl. 239/205; 239/570; 239/571; 239/203

(57) ABSTRACT

A flow control valve favorably employable for sprinkler is composed of a cylindrical housing and control means comprising an upper spring, a floating cover disc, a lower spring, a floating hollow cylinder valve, and a valve seat arranged within the cylindrical housing, in which the cover disc is composed of a disc body and plural legs attached to a side face of the disc body and extending downwardly; the cylindrical housing is composed of a bottom fluid inlet, a top fluid outlet and a fluid passage and has plural guides for vertical movement of the legs of the cover disc on its inner surface; the cylinder valve is detachably placed on the valve seat and has an upper opening, a bottom cap, a flange formed in a lower portion of the valve and a side opening formed in a portion lower than the flange; the upper spring is in contact with the top outlet of the housing at its upper end and with an upper surface of the disc body of the cover disc at its lower end; the lower spring is arranged around the cylinder valve, in contact with lower ends of the plural legs of the cover disc at its upper end, and is in contact with the flange of the cylinder valve at its lower end; and the valve seat fixed to the housing in a lower portion.

### FIELD OF THE INVENTION

This invention relates to a flow control valve and more particularly to a flow control valve which functions through pressure compensation.

### BACKGROUND OF THE INVENTION

A sprinkler for irrigation such as pop-up lawn faucet is generally equipped with a flow control valve (or a pressure regulator). Sprinklers installed in different places generally receive water of different pressures. In more detail, the water of different pressures are supplied to sprinklers which are placed at different distances from the source of water or which are placed at different heights. If one sprinkler is placed very near the water source and other sprinkler is placed far from the water source, the former sprinkler receives water of high pressure and sprays a large amount of water rapidly, while the latter sprinkler receives water of low pressure and sprays only a small amount of water slowly. If one sprinkler is placed on a field and other sprinkler is placed on a hill, the former sprinkler receives water of high pressure and sprays a large amount of water rapidly, while the latter sprinkler receives water of low pressure and sprays only a small amount of water slowly.

In the above-mentioned cases, it is necessary to mount a pressure regulator into the sprinkler to make the pressure applied to the sprinkler substantially even and the amount of sprayed water substantially even.

There are other cases in which the flow control valves are required. Even when risers having spray nozzles (water outlets) of different numbers are mounted to sprinklers, it is desired to adjust the amount of water sprayed through each nozzle substantially even.

U.S. Pat. No. 4,913,352 describes a pop-up irrigation sprinkler having a tubular pressure regulator mounted for movement in the pop-up stem and a funnel shaped grit protector shroud mounted within the step above the pressure regulator to direct deleterious particulate matter downwardly through the pressure regulator.

U.S. Pat. No. 5,779,148 describes a pop-up sprinkler with pressure regulator. The pop-up sprinkler described in the patent includes a housing, a riser in the housing movable between an extended position in which the riser extends from the housing and a retracted position in which the riser is retracted from the extended position and a pressure regulator in the riser. The pressure regulator can be constructed as a cartridge or separate unit and installed in the riser. The riser has an aperture adjacent the pressure regulator and the aperture is between first and second axially spaced seals in the extended position so as to reduce the likelihood of clogging of the aperture.

The present inventor considers that the pressure regulators proposed in the above-mentioned United States Patents has problems in their practical uses in that the structure is complicated and the regulator needs to form an aperture for sensing the atmospheric pressure surrounding the regulator assembly. The aperture is sometimes clogged by dust.

### SUMMARY OF THE INVENTION

It is an object of the invention to provide a flow control valve or a pressure control valve that has a relatively simply structure and does not need to have the aperture.

The present invention resides in a flow control valve (or a pressure regulator) comprising a cylindrical housing and control means comprising an upper spring, a floating cover disc, a lower spring, a floating inner hollow cylinder valve, and a valve seat arranged within the cylindrical housing, in which

the floating cover disc comprises a disc body and plural legs attached to a side face of the disc body and extending downwardly;

the cylindrical housing comprises a bottom fluid inlet, a top fluid outlet and a fluid passage arranged between the inlet and the outlet, and has plural guides for vertical movement of the plural legs of the cover disc on an inner surface thereof;

the floating inner hollow cylinder valve is detachably placed on the valve seat and has an upper opening, a bottom cap, a flange formed in a lower portion of the cylinder valve and a side opening formed in a portion lower than the flange;

the upper spring is in contact with the top fluid outlet of the housing at an upper end thereof and in contact with an upper surface of the disc body of the cover disc at a lower end thereof;

the lower spring is arranged around the cylinder valve, is in contact with lower ends of the plural legs of the cover disc at an upper end thereof, and is in contact with the flange of the cylinder valve at a lower end thereof;

and

the valve seat fixed to the cylindrical housing in a lower portion thereof.

The invention further resides in a pop-up sprinkler for irrigation comprising a cylindrical water passage, a riser that is vertically movable when pressure of water in the water passage varies, and a flow control valve of the above-mentioned invention at the bottom of the water passage.

### BRIEF DESCRIPTION OF THE DRAWING

FIG. 1 is a partially sectional front view of a flow control valve of the invention.

FIG. 2 is a schematic view illustrating parts constituting the flow control valve of FIG. 1.

FIG. 3 is a front sectional view of a housing of the flow control valve of FIG. 1.

FIG. 4 is a front view of a floating cover disc of the flow control valve of FIG. 1.

FIG. 5 is a partially sectional front view of a floating inner hollow cylinder valve of the flow control valve of FIG. 1.

FIG. 6 is a sectional front view of a valve seat of the flow control valve of FIG. 1.

FIG. 7 is a partially sectional front view of a pop-up sprinkler of the invention into which a flow control valve of FIG. 1 is mounted.

FIG. 8 is a partially sectional front view of a flow control valve of FIG. 1 in which water is supplied stably from the bottom inlet, and in which both of the inner cylinder valve and the cover disc elevate in the housing.

FIG. 9 is a partially sectional front view of a flow control valve of FIG. 1 in which water is supplied under increased pressure from the bottom inlet, and in which the inner cylinder valve further elevates while the cover disc maintains the position illustrated in FIG. 8.

FIG. 10 is a partially sectional front view of another flow control valve of the invention which is mounted into a sprinkler.

### DETAILED DESCRIPTION OF THE INVENTION

The present invention is further described by referring to the figures given in the attached drawings.

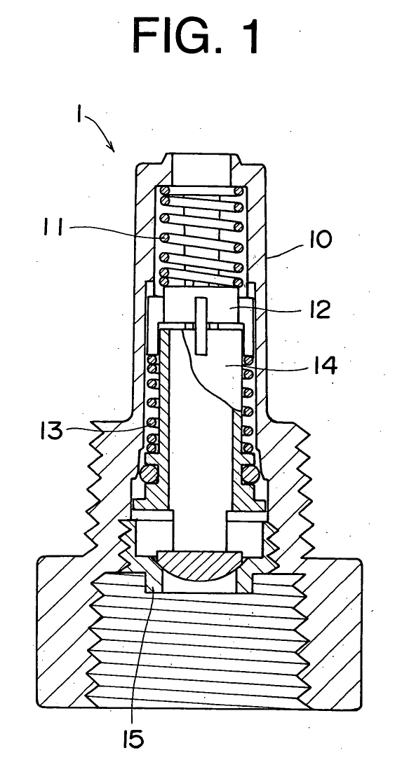

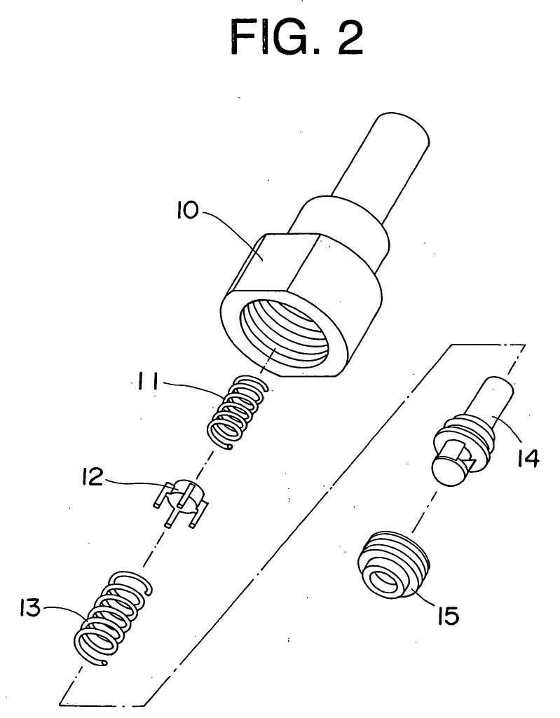

FIG. 1 illustrates a flow control valve (or a pressure regulator) of the invention in the form of a partial sectional view, and FIG. 2 illustrates each of parts constituting the flow control valve of FIG. 1.

In FIGS. 1 and 2, the flow control valve 1 of the invention is composed of a cylindrical housing 10 and control means comprising an upper spring 11, a floating cover disc 12, a lower spring 13, a floating inner hollow cylinder valve 14, and a valve seat 15 arranged within the cylindrical housing 10. Both of the upper spring 11 and lower spring 13 preferably are coil springs. Each coil spring can be composed of plural coil spring units, such as a combination of a strong coil spring unit and a weak coil spring unit. The plural coil spring units can contain a joint for combining the spring units.

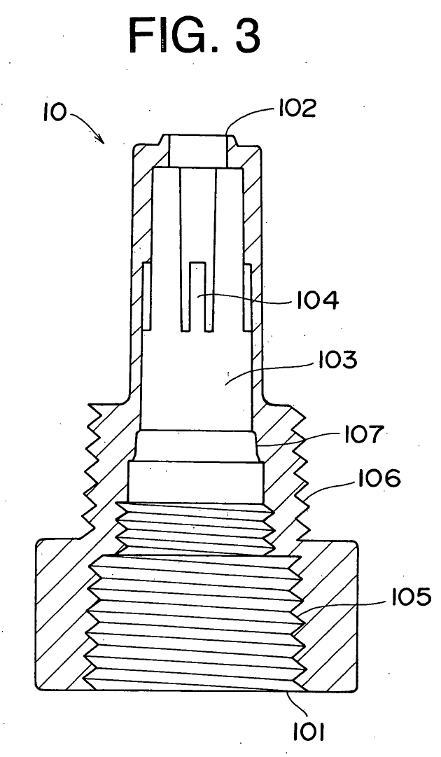

FIG. 3 illustrates the cylindrical housing 10 of the flow control valve of FIG. 1. The cylindrical housing 10 is composed of a bottom fluid inlet 101, a top fluid outlet 102 and a fluid passage 103 arranged between the inlet 101 and the outlet 102, and has plural guides 104 for vertical movement of the below-mentioned plural legs 122 of the cover disc 12 on its inner surface.

The cylindrical housing 10 preferably has a screwed inner surface 105 in its bottom position and a screwed outer surface 106 in a its middle position. The screwed inner surface 105 can serve to firmly fix a water supply pipe (not shown) into the bottom of the housing 10. The screwed outer surface 106 can serve to firmly fix the housing 10 into a bottom of a sprinkler (not shown in FIG. 3).

The cylindrical housing preferably has a downwardly extending tapered space 107 in the vicinity of the position of the below-mentioned O-ring 145 of the cylinder valve 14.

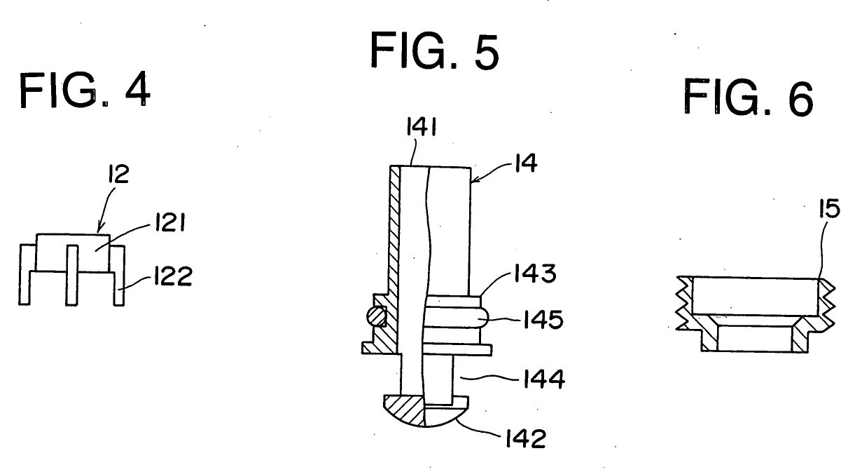

FIG. 4 illustrates the floating cover disc 12 which is composed of a disc body 121 and plural legs 122. The plural legs 122 are attached to the side face of the disc body 121 and are extending downwardly.

FIG. 5 illustrates the floating inner hollow cylinder valve 14 which is placed detachably on the valve seat 15 and has an upper opening 141, a bottom cap 142, a flange 143 formed in a lower portion of the cylinder valve and a side opening 144 formed in a portion lower than the flange 143. The inner hollow cylinder valve 14 preferably has an O-ring 145 therearound in a portion lower than the flange 143 but higher than the lower side opening 144. In this case, the housing 10 preferably has a downwardly extending tapered space 107 (see FIG. 3) in the vicinity of the position of the O-ring of the cylinder valve 14, as is shown in FIG. 1.

FIG. 6 illustrates the valve seat 15 which is fixed to the cylindrical housing 10 in its lower portion.

In FIG. 1, the upper spring 11 is in contact with the top fluid outlet of the housing 10 at its upper end and in contact with an upper surface of the disc body of the cover disc 12 at its lower end.

The lower spring 13 is arranged around the cylinder valve 14, is in contact with lower ends of the plural legs of the cover disc 12 at its upper end, and is in contact with the flange of the cylinder valve 14 at its lower end.

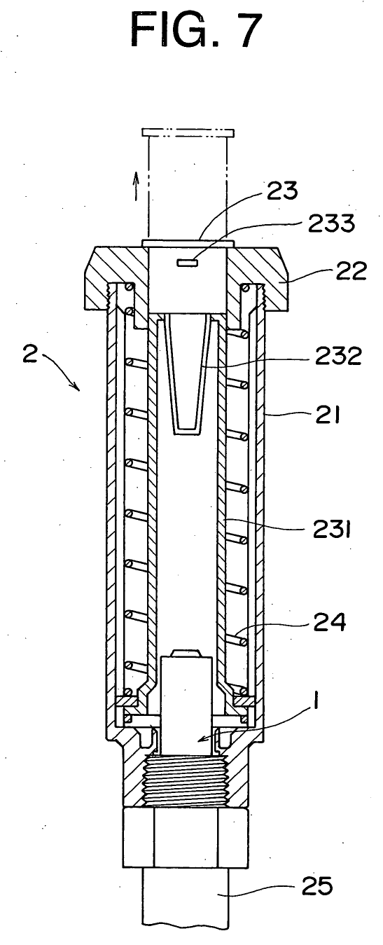

FIG. 7 illustrates a pop-up sprinkler into which a flow control valve of the invention is mounted. In FIG. 7, the sprinkler 2 is composed of a cylindrical housing 21, a head cover 22 covering the housing 21, a riser 23 composed of an inner cylinder 231 forming a water passage and a filter 232, a spring 24 supporting the inner cylinder 231 within the housing 21, and a flow control valve 1 of the invention. The riser 23 has a water outlet 233 near the top. The riser 23 takes a retracted position when water is not supplied into the inner cylinder 231, but is upwardly moved to take an extended position, when water is supplied into the inner cylinder 231. A water supply tube 25 is fitted into the water inlet 101 of the housing 10 of the flow control valve 1.

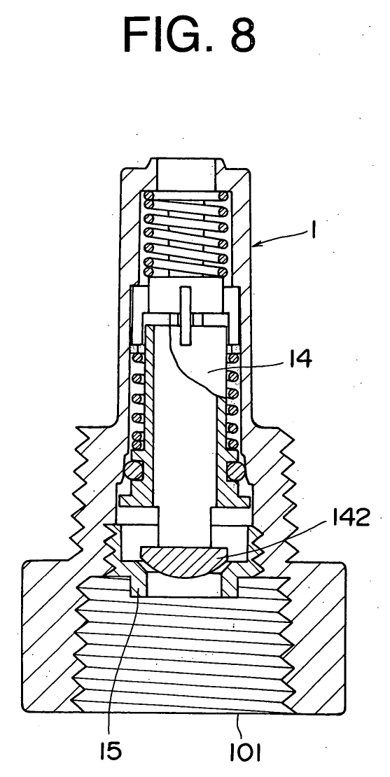

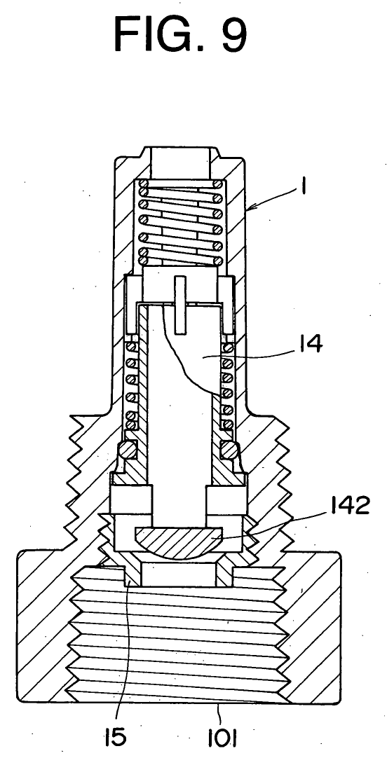

FIGS. 8 and 9 illustrate operation of the flow control valve of the invention.

FIG. 8 illustrates a flow control valve of FIG. 1 in which water is supplied stably from the bottom inlet, and in which both of the inner cylinder valve and the cover disc elevate in the housing.

When water is supplied to the bottom fluid inlet 101, the floating inner hollow cylinder valve 14 detaches from the valve seat 15 and elevates within the housing 10. The water runs up through the space formed between the valve seat 15 and the bottom cap 142, and runs into the cylinder valve 14 through the side opening 144. The water also runs up through a clearance formed between the housing 10 and the cylinder valve 14. The latter water can wash the O-ring 145 to remove inadvertently deposited dust. The cylinder valve 14 further elevates within the housing 10, and then the O-ring 145 is brought into contact with the downwardly extending tapered space 107 of the housing 10. When the O-ring 145 is brought into contact with the tapered space 107, the water flow which runs up through the clearance formed between the housing 10 and the cylinder valve 14 ceases, and the water flow running up through the cylinder valve 14 only continues.

The water flow running up through the cylinder valve 14 is brought into contact with the bottom surface of the cover disc 12 and pushes up the cover disc 12. The cover disc 12 is kept to take a position above the top head of the cylinder valve 14 with a certain space by the force balanced between the upper spring 11 and the lower spring 13 when no water is supplied into the flow control valve 1. However, when the running water flow is brought into contact with the bottom surface of the cover disc 12, the cover disc 12 elevates by the force of the running water and the lower spring 13 elevating simultaneously with the elevation of the cylinder valve 14. Therefore, the space between the top head of the cylinder valve 14 and the bottom surface of the cover disc 12 increases, as compared with the original space shown in FIG. 1.

The water flow running up through the cylinder valve 14 is then runs through a space between the disc body 121 and plural legs 122. The water further runs up through the space above the cover disc 12 and finally runs out through the upper opening 102 of the housing 10.

If the pressure of supplied water increases further, the pressure of water further pushes up the cylinder valve 14, but further elevation of the cover disc 12 is inhibited at the upper edge of the cover disk guide 104 of the housing 10 (see FIG. 3). Therefore, the space between the head of the cylinder valve 14 and the bottom surface of the cover disc 12 decreases, as is illustrated in FIG. 9. Nevertheless, since the flow rate of the water running up through the cylinder valve increases by the increased pressure of the supplied water, the amount of water running out through the upper opening 102 is kept at an almost same level regardless of the increase of pressure of the supplied water.

In the case that the riser 23 is replaced with a different riser having an decreased number of the nozzles (water outlets) 233 or replaced with a different riser having a nozzles of a smaller inner diameter, the pressure in the space above the cover disc 12 increases. The increased pressure in the space above the cover disc 12 then pushes down the cover disc 12, and hence the space between the bottom surface of the cover disc 12 and the head of the cylinder valve 14 decreases, as is seen in FIG. 9. In this case, since the flow rate of the running water does not vary, the amount of the water running through the space between the disc body 121 and plural legs 122 decreases. Hence, the amount of water supplied into each nozzle or the narrow nozzle is kept at an almost same level.

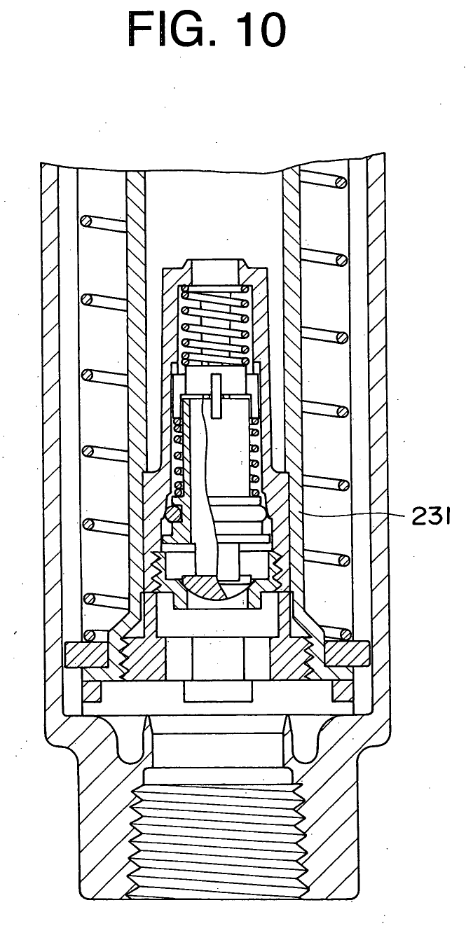

FIG. 10 illustrates a flow control valve of a different type but still according to the invention. The flow control valve of FIG. 10 is fully mounted into the inner cylinder 231 and moves simultaneously with the riser 23.

Thus, the flow control valve of the invention can be installed not only in the riser but in the sprinkler. Further, the flow control valve of the invention can be placed in the middle of a water pipe connecting the water source and the sprinkler.

What is claimed is:

1. A flow control valve comprising a cylindrical housing and control means comprising an upper spring, a floating cover disc, a lower spring, a floating inner hollow cylinder valve, and a valve seat arranged within the cylindrical housing, in which
the floating cover disc comprises a disc body and plural legs attached to a side face of the disc body and extending downwardly;
the cylindrical housing comprises a bottom fluid inlet, a top fluid outlet and a fluid passage arranged between the inlet and the outlet, and has plural guides for vertical movement of the plural legs of the cover disc on an inner surface thereof;
the floating inner hollow cylinder valve is detachably placed on the valve seat and has an upper opening, a bottom cap, a flange formed in a lower portion of the cylinder valve and a side opening formed in a portion lower than the flange;
the upper spring is in contact with the top fluid outlet of the housing at an upper end thereof and in contact with an upper surface of the disc body of the cover disc at a lower end thereof;
the lower spring is arranged around the cylinder valve, is in contact with lower ends of the plural legs of the cover disc at an upper end thereof, and is in contact with the flange of the cylinder valve at a lower end thereof;
and
the valve seat fixed to the cylindrical housing in a lower portion thereof.

2. The flow control valve of claim 1, in which both of the upper spring and the lower spring are coil springs.

3. The flow control valve of claim 1, in which the inner hollow cylinder valve has an O-ring therearound in a portion lower than the flange but higher than the side opening, and the housing has a downwardly extending tapered space in the vicinity of the position of the O-ring of the cylinder valve.

4. The flow control valve of claim 1, in which the housing has a screwed inner surface in a bottom portion thereof.

5. The flow control valve of claim 1, in which the housing has a screwed outer surface in a middle position thereof.

6. A pop-up sprinkler for irrigation comprising a cylindrical water passage, a riser that is vertically movable when pressure of water in the water passage varies, and a flow control valve of claim 1 at the bottom of the water passage or riser.
